(19) United States
(12) Patent Application Publication
(10) Pub. No.: US 2012/0287224 A1
(43) Pub. Date: Nov. 15, 2012

(54) Video chat within a webpage and video instant messaging

(75) Inventor: Nicholaz F. Paris, Manchester, NH (US)

(73) Assignee: Nicholaz F. Paris, Goffstown, NH (US)

(21) Appl. No.: 13/106,791

(22) Filed: May 12, 2011

(51) Int. Cl. H04N 7/14

(52) U.S. Cl. 348/14.08; 348/E07.077

(57) ABSTRACT

The Invention includes methods for video chat contained within a webpage and video instant messaging. A method of using video chat contained within a webpage allowing users of said webpage to video chat while utilizing all other features of the webpage and utilizing network resources rather than their own. A method of instant messaging using video wherein the user or users send a message in the same manner as a traditional instant message and the receiving user receives the message also in the same manner and both parties utilize video as the message body I.E. The message is a video and is instantly or nearly instantly received by the other party. A method of instant messaging using video wherein the user downloads software designed to allow video transfer in the form of a message instantly or nearly instantly between other users of the software.

### FIELD

Embodiments and/or representations of the invention relate to video chat services and live chat services provided by a website and controlled by a server to registered users of said website. Embodiments and/or representations of the invention also relate to video instant messaging and video instant messaging services provided by a website, design, interface and a program for video instant messaging outside of a website or webpage or the like there of.

### BACKGROUND OF THE INVENTION

To address the demand for video over ip and video messaging. As the internet continues to grow the demand for Video over IP services and Voice over IP has increased. Consumers currently have to download software to their computer systems in order to use such services and as such their is a potential to download malicious software e.g. viruses and tracking software etc, if not downloaded from a trusted and reliable source. Current applications of video over IP have limited reliability whereas the software puts most of the burden for the use of resources on the consumers hardware and as such is limited to consumers hardware capability. Messaging via chat services is also very limited whereas the message body is limited to the text it contains and as such can be interpreted in various ways. Currently there is no system to enable consumers to send video messages without downloading software and using the consumers hardware resources furthermore there is currently no service to allow consumers to chat via streaming or live video without downloading software and using the consumers hardware resources or that uses a consumer friendly web page that allows consumers to multitask including downloading music, movies and games or update daily statuses or that a system that exist is a stand alone design thereby limiting consumers to the interface of the design itself.

### BRIEF DESCRIPTION OF THE INVENTION

The invention embodiments contained herein are a design to video chat within a webpage and video instant message within a web page and a stand alone program. The basic use for such a product(s) can be useful in almost every website. It allows users to see the person to whom they are speaking while using other features of the website such as: uploading pictures, viewing directions, playing games and more. It allows users to chat face to face without changing between one program and another or exiting the web page they are on. It is also useful that a user can video chat without switching web pages. The video chat within a webpage is not that of a stand alone design. It is specifically designed for a website. The video chat is a window within a web page but is not limited to such. The video messenger is part of the design where the controls on the toolbar allow users to send video messages to other users. The user receiving the message receives the message. Upon receiving the video message the video is played back by the default video player. After the video is played the user receiving the video message has an option to reply to the video message, delete, save, forward or the like there of. Video instant messenger is not to be confused with other video over ip software programs. This design works exactly like traditional instant messages only it is used with video instead of text. The video chat interface works using a user-controlled graphical user interface (GUI) integrated into a web page and designed to work with Transfer Control Protocol (TCP/IP). Transfer Control Protocol works by sending data bits in packets. A packet is a sequence of octets (a unit of digital information in computing and telecommunications that consists of eight bits). The Packets are exchanged by way of the Internet Protocol (IP) and arranged and organized using Transfer Control Protocol (TCP). A server or server(s) Receives the packets and handles the functions contained within the programming of the design. TCP uses port numbers to identify sending and receiving application end points on a host. Both sides of a TCP connection have an associated 16-bit unsigned port number (0-65535) reserved by the sending or receiving application. Arriving TCP data packets are identified as belonging to a specific TCP connection by its sockets, that is, the combination of source host address, source port, destination host address, and destination port. This means

that a server computer can provide several clients with several services simultaneously, as long as a client takes care of initiating any simultaneous connections to one destination port from different source ports. The Embodiment to contain this technology within a webpage is that the end user will receive the best possible web experience while engaged in the service. Users will find a much more rewarding experience by the use of such services.

### BRIEF DESCRIPTION OF DRAWINGS

The following description includes discussion of various figures having illustrations given by way of example of implementations of embodiments of the invention. The drawings should be understood by way of example, and not by way of limitation.

FIG. 1 is a block diagram embodiment of a web based design using system controls and a Graphical User Interface (GUI) integrated into a website to initiate, record, save, copy, start, end, choose, display, send, conference and receive live video from another registered user of the website controlled by a server.

FIG. 2 is a block diagram of an embodiment of a web based design that connects a server or server(s) to a web page and to the graphical user interface (GUI) as described in FIG. 1.

FIG. 3 is a block diagram of an embodiment of a web based design that connects the (GUI) controls to the web page and is then sent to a server or server(s) to provide information related to the video chat interface to the server or server(s)

FIG. 4 is a block diagram of an embodiment of a video display to view output of the received video information provided to the server by another registered user by way of the controls that use a graphical user interface (GUI) as described above.

FIG. 5 is a block diagram of the embodiment of controls to initiate, record, save, copy, start, end, choose, display, send, conference and receive video data as described above.

FIG. 6 is a block diagram of the embodiment of a video instant messaging program integrated into a website and designed to allow multiple users to video instant message within a webpage.

FIG. 7 is a block diagram of the embodiment of a website designed to integrate video instant messaging and live video chat into a website allowing end users to video chat live and send and receive video messages.

FIG. 8 is a block diagram of the embodiment of a computer software program with the capability to receive, send, record, transmit, display, playback, save, delete, copy, choose, initiate or any other means of transmitting video via messaging software as it pertains to instant messages.

### DETAILED DESCRIPTION

The field of the invention relates to Internet communication and the near instantaneous delivery and display of audio and video utilized to such that a consumer registered to a website can experience

live video streams, feeds or messages and/or send the same to other registered users of a website. It also relates to video instant messaging program embodiments. While the present invention is susceptible of embodiments in various forms, there is shown in the drawings and will hereinafter be described some exemplary and non-limiting embodiments, with the understanding that the present disclosure is to be considered an exemplification of the invention and is not intended to limit the invention to the specific embodiments illustrated. It should be further understood that the title of this section of this specification, namely, “Detailed Description Of The Invention”, relates to a requirement of the United States Patent Office, and does not imply, nor should be inferred to limit the subject matter disclosed herein. The internet, as used herein, includes the world wide web (web) and other systems for storing and retrieving information using the internet. To view a website, a user typically points to a web address, referred to as a uniform
resource locator (URL), associated with the web site. At least one embodiment of the system is designed to allow thousands of users to use video streaming or live video chat and/or to send and receive video messages over the internet. Such embodiment described is integrated into a social networking website and thereby eliminates the need to download any unnecessary software or potentially download malicious or harmful software. All embodiments contained herein are designed to work together as a complete website with the above embodiments contained within the website and are only limited to such. The design of the above embodiments uses programming codes and website builder tools to pull the above embodiments together and allow them to run smoothly with little or no latency in the receiving users web browser. The video chat services or live video chat services and the video instant messenger service provided and described above provide a simplified way for users to communicate over the internet and keep in touch with friends and family. Prior art systems did not allow users to send video via a message within a website and save said message to users computer system, furthermore prior art systems either had to have software installed or were a stand alone design thereby limiting users to the video chat interface associated with the design. For example if a user registers and logs in the website they are only limited to their internet connection. They can video chat via the video instant messenger without using up valuable hardware resources on their computer leaving the computer free to complete other tasks. Resources on prior systems used are comprised of memory or RAM (random access memory), hard drive space, video card, ethernet card, network, display, Central Processing Unit (CPU) usage and version of Operation System (OS) used. The server associated with the website and the above named embodiments take on almost all of the burden except for the users audio/video input device software usage. Next, the use of TCP/IP related to designs that allow video transfers between users are limited by the software contained within the design. An example being that a software capable of sending video messages via the internet is limited to the use of network configurations for players, end user hardware resources, Central Processing Unit (CPU), Random Access Memory (RAM) and other factors. The limit and scope of the design described in the description above is such that an end user with an internet connection can without using up their resources or having a specific hardware design, use the video instant messenger contained within a webpage to communicate with other end users. It also does incorporate TCP/IP into the design but not to an extent that limits the design to an end users hardware or built in software. Third, The design described above is not specifically a stand alone design, though it is a portion of the figures contained herein to have a stand alone design, the main portion of the design is to integrate this into a webpage, website or the like there of. It uses a centralized server to control both parties video display, by doing so it leaves the users hardware free from clutter and possibly binding up their system. It is Incorporated into a website that allows users to network socially, download music, movies, video games, view other users profiles, play online games, get directions, or link to another site simultaneously while they are in a video conversation with other user(s). It uses TCP/IP directed toward the website to allow transfer of video through the website. The design for video instant messages is very similar to instant messaging whereas in an instant messaging program a user can pick from a list of people to send to, type input from a keyboard into the instant messenger and when the user clicks send the message is sent to the corresponding user. The receiver of the instant message receives the message almost instantly and a box with the contained text pops up on the users screen allowing the user to view the instant message, reply forward and more. With the Video Instant messenger described above a user can send and receive messages via the website and/or stand alone software that contain a pre-recorded message. They can also save, copy, forward, delete and transfer the video message.

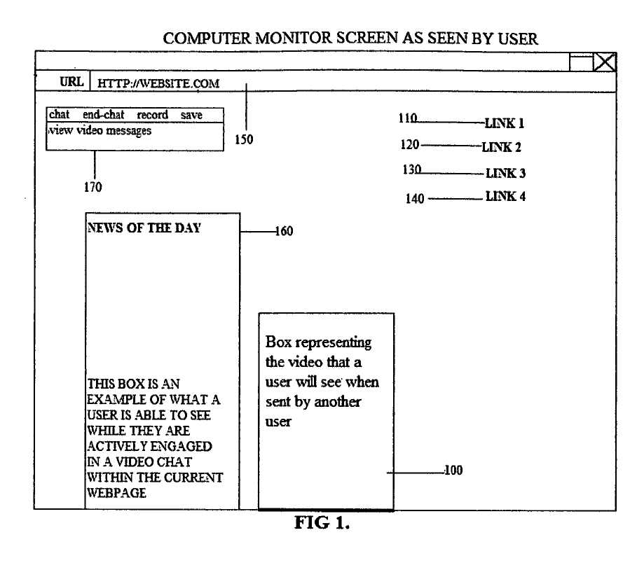

Referring to FIG. 1. This is a representation of the website designed for the video chat within a web page. It is simply a representation of what the web page will look like with the program implemented and not necessarily the program itself. The program itself is dependent on the method in which the webpage is designed I.E. HTML, XML, C#, C+, C++ ETC. This embodiment encompasses all programming languages and as such is not limited to the design itself but the embodiment of the design and all aspects there of. The web page is a representation. Exact details will be dependent on the programming language

and/or webpage design tools used to the webpage itself and as such the figure should not be limited to the web page design but encompass the embodiment of the web chat interface contained within the web page. Where the video feed viewed by user (100) is a representation of what a user is able to see when engaged in video chat within the current webpage. 110, 120, 130, 140 are representations of links that a user may click and still be engaged in the video chat. 150 represents the (URL) uniform resource locator that a user can type in when they have opened their internet browser. 160 is an example of what users can see in the background when engaged in video chat within a webpage. Users are able to change and modify information on this webpage while engaged in the video chat. 170 are clickable buttons users may use to control the video chat I.E. start, end, save, display and/or choose the user in which to engage the video chat with.

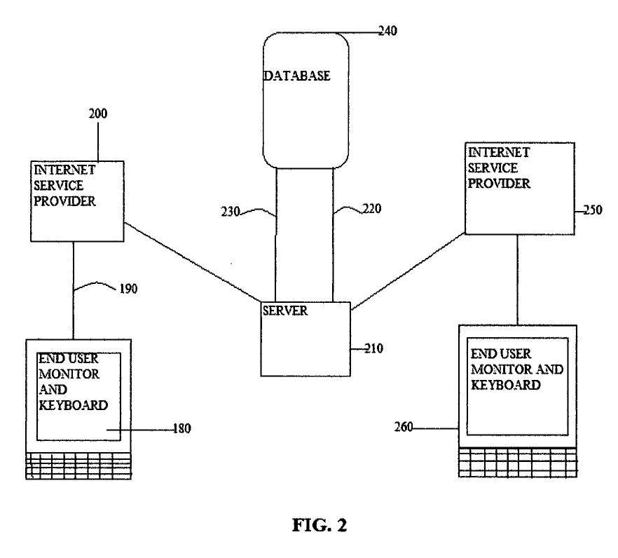

FIG. 2. There is a picture of a connection to a server 210 from a webpage 180, 260. The connection is made through the web design program used to implement the webpage. In other words the exact programming language is dependent on the method in which the webpage is designed I.E. HTML, XML, C#, C+, C++, ETC. The basics to send and receive remain relatively the same. The first end user 180 initiates the chat by sending a request to the server 210, relayed by the Internet service provider 200. The server verifies the necessary information on the database 240 and proceeds to open a chat interface with the end user requested 260. After end user 260 accepts the request a chat is opened between both users 180, 160. Using a combination of Windows Communication Foundation functions in conjunction with HTML and TCP/IP a connection to the server for the transfer of video packets can be made. Packets with information contained within the video message will be transferred by the server 210 and displayed in the end users web browser 180, 260 via a display program designed to work with this method of communication. The Graphical User Interface I.E. clickable buttons on the webpage allow users to control what is sent, only limited to the buttons themselves which serve only as basic functionality of the program. The clickable buttons allow users to record, save, send, receive and a view messages link.

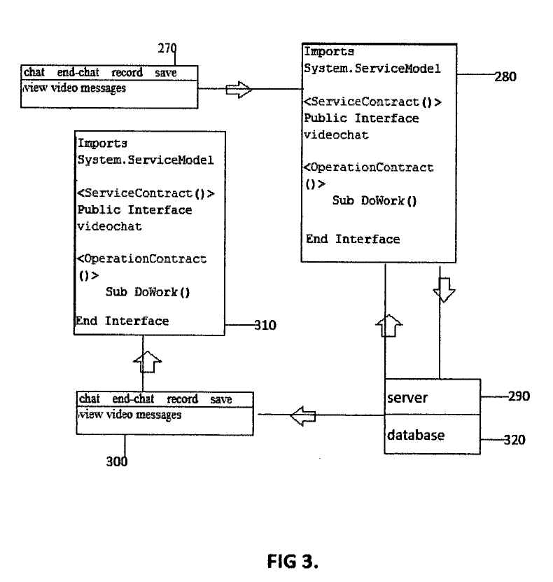

FIG. 3. Refers to the controls (270, 300) used to send information from the webpage via the video chat program, to the server (290) and accordingly sent to the receivers web browser to be displayed. (280, 310) are the program handling the video chat and the information sent and received by the server. The information that is sent refers to bits of information and data packets controlled primarily by program design and handled accordingly by the server (290). The server (290) or server(s) to which information is sent compiles, stores and transfers information sent to it via the web page initiated by the controls and handled by the program design for the web chat service. The controls depicted in this figure are an example and should be treated as such. Exact control display is dependent on the method in which the webpage was built and/or the webpage building tools used to design it. It is the embodiment of the display that controls the webpage that should be considered.

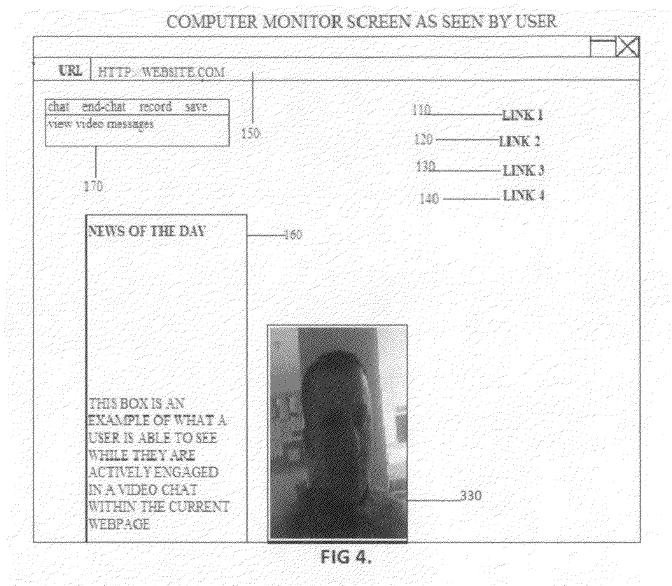

FIG. 4. (330) Is an example of what type of picture users will see when the video chat within the web page starts. The picture is merely a representation of the video chat interface itself and should in no way be limited to that. A user will see the corresponding video from the user sending the video and simultaneously be sending video to that user. 110 through 170 are the same as FIG. 1. FIG. 4. is an embodiment of the video chat interface that a user will see. The video being displayed may be displayed by various display methods and as such the embodiment of the design should not be limited to one display method or method(s). The video chat interface is unique in that it is contained within a web page that allows users to use all other basic functions of the web page while engaged in a video chat.

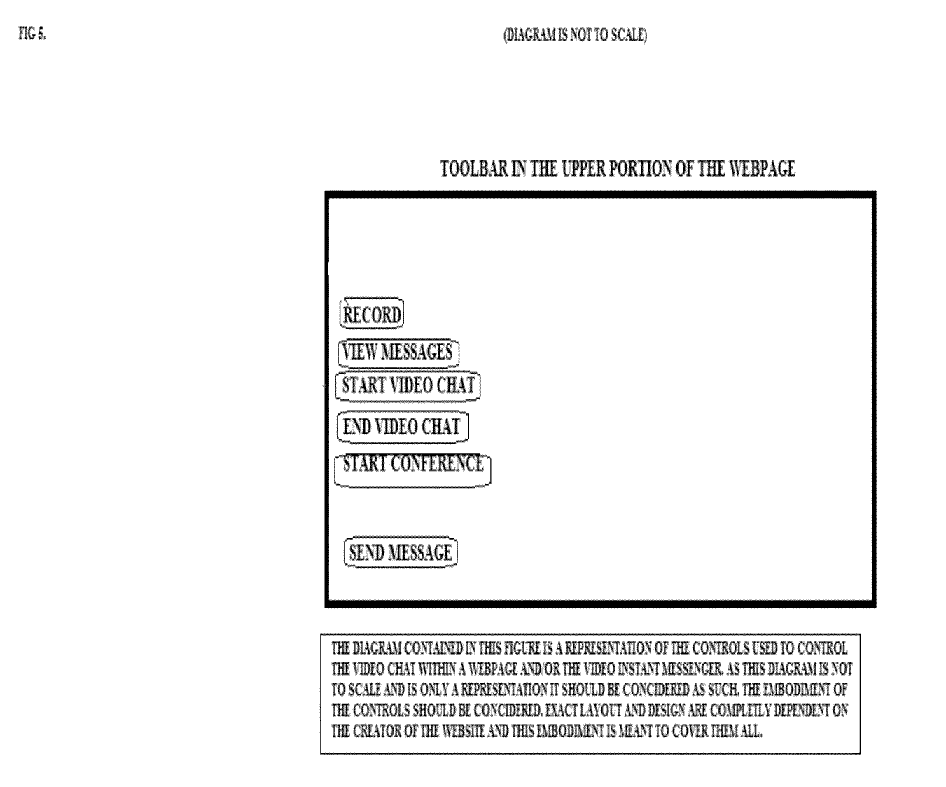

FIG. 5. There is a picture of a box with buttons to control the video chat or video messages (350). The box is representing a tool bar type object within a webpage that has various buttons for users to click. Including but not limited to a record, save, send, receive and view messages link. It is controlled by a server. By doing so it eliminates the need for an end user to have a specific hardware setup. The design is comprised of programming code designed to work specificity within a webpage. Using TCP/IP and RTP as well as specific programming and a server capable of handling these types of request, the function of video chat within a webpage is accomplished. 340 is a simple description of the controls. 350 is an exploded view. The actual size is dependent on the webpage design, programming or other factors.

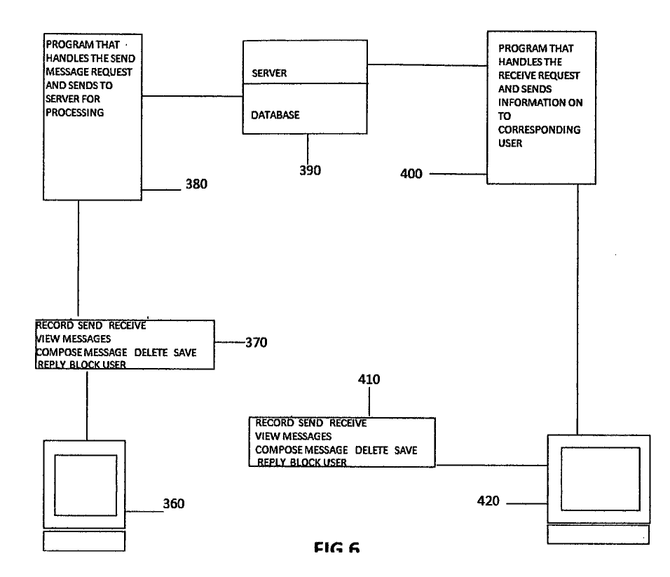

FIG. 6. Is a representation of a the integrated program for video instant messaging within a webpage. 360 is an example of an end user computer. The end user (360) initiates the message by using the controls (370) to record the message and then clicking the button send (370). The program handling the request (380) sends the video message to the server where it is then processed and sent to the corresponding user (420). The program handling the message received (400) decodes the message and displays the message in the corresponding users browser (420). The corresponding user (420) then has the option to delete, save, reply, block user etc (410). The video instant messenger is the same as traditional instant messaging in that it is handled the same way. The noticeable difference is that the message is a video message instead of the traditional text. This representation should not be limited by program itself but the embodiment of the design. The representation shows a box representing the controls (370), described in the above figure(s), that allow a user to almost instantaneously send and receive the video instant message (VIM). The display of the video will play in a separate window. The display should not be limited to the method in which the video is played back to the user but the embodiment of the design of the video instant messaging service (VIMS). There can be multiple ways to display the message on a users computer or device and as such should not limited by specific programming or specific methods of display. The exact program language is dependent on the creator of the website, programming language and/or website building tools. The embodiment of the design is what should be considered.

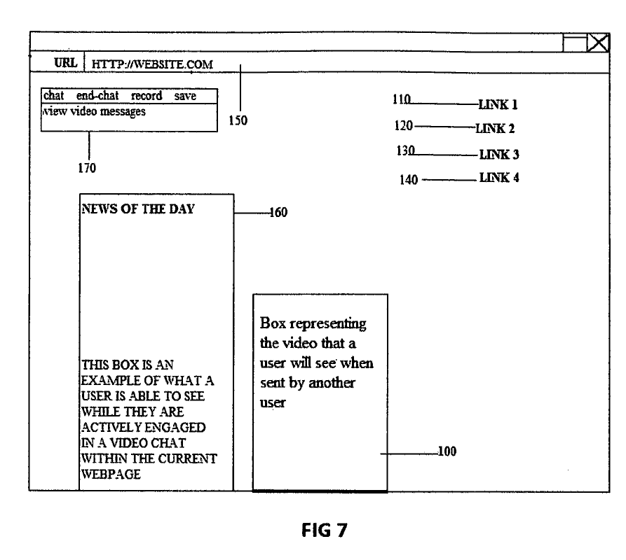

FIG. 7. This is a representation of the embodiment of the design for a webpage that integrates the video chat services and video instant messaging services into the page itself. FIG. 7 is the same picture as previous figures. It is simply a representation of what the webpage can look like with the video chat and video instant messenger intergrated. 100 is a representation of where the video may be located. 110 through 140 are links that a user may click while engaged in video chat. 150 is the top of a browser, representing where a user can type the (URL) Uniform Resource Locator, close the current page, or minimize the browser. The web page itself is dependent on specific programming and as such should not be limited to the programming of the webpage but the embodiment of the design to integrate video chat services and video messaging into said webpage. Web pages can be built in many forms and many designs and by any number of people or companies as such the webpage referred to in this description is that which contains the above embodiments. The web page shown in this representation is not an exact replica of what the web page should look like to an end user and should not be limited to the layout of the webpage. The representation there for is for a webpage with integrated video chat and video messaging and to show an example of this.

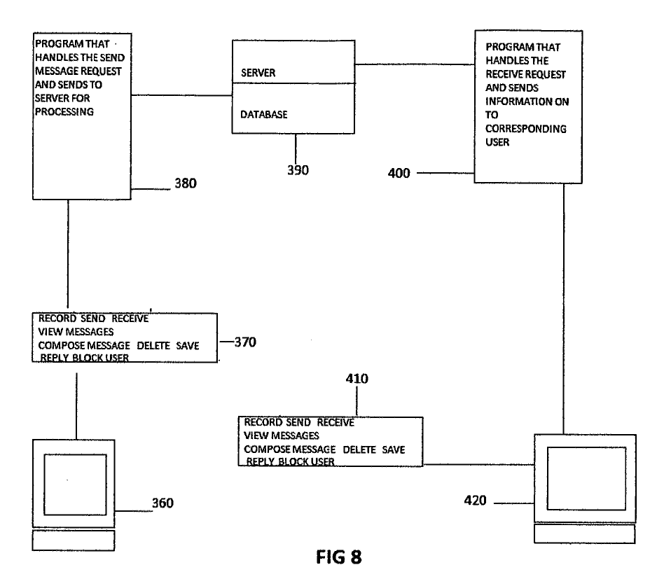

FIG. 8. This is a representation of the video instant messenger similar to that of regular instant messaging where a user sends a message to another user of the instant messaging program and the user without having to open the message receives the message in their browser, window, desktop or the like there of and the message is played. This FIG is the same as previous figures because the design is the same except that the program itself is stored on the users computer or device instead of a server. 360 is the initiating user. Using the controls (370) user sends video message to another user. The video message is handled by a program designed to work with the server (380). The program sends the information to the server (390) where it is then processed and sent to the corresponding user. The corresponding user having the same program receives the message via the program and the program then handles the request accordingly, Displaying the message in the users browser. The user can then decide to save the message. If the user does not decide to save the message the server will not store for later recovery. In this program a user must have the proper hardware to use it as a stand alone feature. The default video player for the video instant messenger is built into the program itself thereby eliminating the need to have specific players and other software downloaded to their computer. Though the embodiment contained herein indicates there is a default video player, the software program should not be limited to such. A built in video playback feature in this scenario is simply logical to the program design where as the program embodiment can have multiple design features and should not be bound by one specific design feature. The embodiment contained herein thereby is that of multiple video playback programs being able to playback the video contained within the message. Just as an instant message is typed and sent, the video instant messenger is recorded and sent. Using controls which have a graphical user interface (GUI) on the users computer to send, receive, display, record, save or the like there of, a user can control the messages being sent and received. The graphical user interface (GUI) allows users to choose from a list of people to send messages to. It allows users to set their status to, online, away, idle, or any variation related to or the like there of The design of this program involves TCP/IP and other programming and design feature that enable this program to work. The invention is not limited to the particular details and method depicted, and other modifications and applications are contemplated. Certain other changes may be made in the above-described embodiments and methods without departing from the true spirit and scope of the invention herein involved. It is intended, therefore, that the subject matter in the above depiction shall be interpreted as illustrative, and not in a limiting sense.

What is claimed is:

1. A method of using video chat programming in which the video is contained within a webpage, website, server, servers, or any other method of transferring the information, programming, or the like there of, through the internet whereas the method has the attached embodiments contained therein.

2. A method of exchanging video through use of the internet where the user or users can exchange video in a method that can be described as video instant messaging. Where one user records, receives, transfers, displays and/or sends a video through the use of the internet and a webpage, website or other method of transferring information together with any of the attached embodiments, and the other user receives the video message almost instantaneously and is able to reply in the same manner described herein, thereby implementing video instant messaging in any form of design.

3. A method of exchanging video as described above where the user or users exchange video almost instantaneously through the use of an internet connection and the video is delivered to another user in the form of an instant message using video. Video instant messaging is a form of video messaging which users exchange videos in the same manner as a traditional instant message with the use of video as the message.

4. A method of exchanging video which contains any of the attached embodiments and/or any method that uses the attached embodiments for any other purpose.
